(19) United States
(12) Patent Application Publication
(10) Pub. No.: US 2007/0253733 A1
(43) Pub. Date: Nov. 1, 2007

(54) Illumination System

(75) Inventor: Franciscus Henricus, Alphonsus, Gerardus Fey, Eindhoven (NL)

Correspondence Address: HOFFMANN & BARON, LLP, 6900 JERICHO TURNPIKE, SYOSSET, NY, 11791, US

(73) Assignee: C.C.M. BEHEER B.V., Nuenen (NL)

(21) Appl. No.: 11/720,458

(22) PCT Filed: Nov. 30, 2004
(86) PCT No.: PCT/NL05/00820

§ 371 Date: Jun. 14, 2007

(30) Foreign Application Priority Data
Nov. 30, 2004 (NL) 1027627

(51) Int. Cl. G03G 15/22

(52) U.S. Cl. 399/140

(57) ABSTRACT

The invention relates to an illumination system, and to a fluorescent illumination system and fluorescent microscope using the illumination system. The illumination system comprises an LED light source which radiates radiation focussed via an elliptical mirror onto a homogenization bar. This creates a very efficient, intense and stable light source.

The invention relates to an illumination system, comprising a light source with at least one LED which is designed to emit light, an optical element with a focal point, and a homogenization bar, comprising a body with an entry surface and an exit surface, which body substantially transmits the light of the light source, the light source being positioned in the focal point of the optical element, in such a manner that light emitted by the light source can be reflected focussed by the optical element towards an entry surface of the homogenization bar.

DE 103 14 125 has disclosed a device for the illumination of objects, comprising an LED, a collimator lens and a light homogenizer in the form of a bar. The device is used as light source for (fluorescence) microscopy.

The known device has the drawback that the light intensity which can be achieved is not always adequate. In particular, for fluorescence microscopy, a high base light intensity is important, since this determines the strength of the fluorescence signal. Although LEDs have certain advantages over other light sources, such as high-pressure mercury vapour lamps, their light intensity, even when using condenser optics, is often insufficient to provide a usable fluorescence signal.

One object of the invention is to provide an illumination system which can achieve a higher luminous intensity.

The invention achieves this object by the measures of claim 1. The use of a concave mirror as optical element with a focal point offers the advantage that it is easy to form the mirror around the light source, so that in relative terms a larger light-collecting surface area is available, more specifically a larger light-collecting spatial angle, and more light can be focussed.

In a preferred embodiment, the concave mirror comprises an elliptical mirror, preferably with a relative interception angle A of at least 0.8, where A is equal to the (emitting spatial angle of the LED)/2π. An elliptical mirror offers good focussing towards a second focal point of the ellipse. An additional advantage of using a mirror is the fact that a mirror is not subject to any chromatic deviations, whereas lenses, and in particular thick lenses, such as condenser lenses, may be very significantly affected by chromatic aberrations.

Alternatively, it would also be possible, for example, to use a parabolic mirror, which has just one focal point and passes on a parallel beam. Preferably, however, this beam would at most be of the same size as the entry surface of the homogenization bar, since otherwise light is lost. This imposes additional demands on the dimensions of light source, mirror and entry surface, which demands are not present or are present to a much lesser extent if an elliptical mirror is used. In both cases, it is readily possible to make the “opening” of the mirror large, preferably at least 0.8, more preferably at least 1.0 and even more preferably greater than 1.0. In this case, A is a measure of the maximum intercepted angle, where A=(intercepted spatial angle in steradians)/2π. It is clear from this that A is between 0 and 2 and is equal to 1 on interception of a hemisphere, apart from a part of the light which is blocked by the LED or light source.

The relative dimensions of the elliptical mirror will depend on the desired relative interception angle and on the desired maximum angle of incidence on the entry surface. This maximum angle of incidence can be expressed as a numerical aperture Ai=sin(maximum angle of incidence). The numerical aperture Ai is preferably at most 0.25. By way of example, Ai is selected to be from approximately 0.15 to 0.20, preferably even from approximately 0.1. These values give very favourable characteristics for the angle distribution of the light which enters the bar and therefore also which leaves it again. Not only is a relatively small Ai associated with a relatively narrow angle range about the optical axis, but this also means that in turn a relatively narrow light beam emerges from the bar. The illumination system is then eminently suitable for providing a small light spot with good homogenization, of which more details will be given below. A small, homogenous light spot of this type is extremely suitable for, inter alia, fluorescence microscopy, where it is important to illuminate only or at least primarily the region from which a fluorescence signal can also be read. After all, the light supplied in the surrounding area can not only cause disruptive scattered light but can also bleach the fluorescent substance or the material to be detected. It should be noted that this Ai relates to the value at the exit surface of the bar, but in principle the value does not change within the bar.

It should also be noted that the Ai is normally an indication of the width over which the emitted light beam fans out and therefore of the expected size of the light spot. However, this does not take account of an intensity distribution in the beam or spot. In general, there will be a decrease in light towards the edges. If this is taken into account by taking an energy-averaged numerical aperture or an effective numerical aperture, the latter has generally been found to be between ⅓ and ½ of the Ai defined as above. In practice, therefore, an effective numerical aperture of between 0.05 and 0.1 can be taken for the abovementioned values of Ai between approximately 0.1 and 0.25. These latter values often give a more useful indication when estimating the illumination which can be achieved of, for example, a microscope specimen.

The values given above for Ai are preferred values, although other values are readily also possible. The Ai is largely determined by the geometry of the system, such as the shape of the mirror and the distance from the bar, and the emission angle of the light source, which variables are obviously linked. The ratio of the short axis of the ellipse to the long axis of the ellipse determines the spatial angle imaging factor. The LED will be much less of an obstruction to the light path when using a large ellipse than when using a small ellipse. Furthermore, a small ellipse will be much more affected by imaging errors than a large one. There is therefore an optimum for the ratio of the cross-sectional area of the ellipse and the cross-sectional area of the light source. This optimum is determined by practical wishes and is, for example, between 10:1 and 100:1, although without ruling out other values.

In the illumination system according to the invention, the homogenization bar serves to homogenize the light beam, i.e. to create a more homogenous intensity profile. This is based on a reference plane or the desired illumination plane. This homogenization is achieved by the light rays being repeatedly reflected back and forth in the homogenization bar. Since the rays will do this differently with different angles of incidence, the rays will be mixed, so that ultimately the peaks and valleys in the intensity will be smoothed out.

The cross section with respect to the optical axis advantageously may not change. The bar therefore, for example, may not taper, curve or be rotated about the optical axis. If it does do so, the available angle increases towards the end of the bar, which is generally undesirable. However, provided that the homogenization bar is rigid or at least arranged immovably, so that the shape remains substantially unchanged during use, it is possible for the actual illumination profile of each bar to be calculated or determined by tests. For this reason, it is preferable for the homogenization bar to be straight and rigid.

In some other cases, by way of example, bends cannot be avoided, or an altered profile may even be desirable. If the homogenization bar is of flexible design, for example in the case of a glass fibre, it will be possible for the profile to change in the event of any movement, which is less favourable with a view to achieving a reliable and reproducible profile.

Another object of the invention is to further improve the homogeneity of the light compared to the prior art, in particular DE 103 14 125, and especially to achieve this homogenization within a limited volume.

In one embodiment, the homogenization bar has a diameter D and a length L where the relationship between L and D is preferably as follows:

L=(N+½)*D/tan(mean size of the angle in the bar with respect to the optical axis),

where N is an integer number including 0. In this case the mean angle is determined as the energy-averaged angle, i.e. each angle is given a relative weight corresponding to the proportion of this angle in the total energy of the light in the bar.

With a relationship of this nature between the variables of cross section and length of the bar, good homogenization is achieved even with a relatively short length of the bar. A homogeneity of 90 to 98% in a region with a radius of 0.9×the outer radius of the spot can be achieved. Of course, other length/diameter ratios are also possible, for example in order to obtain a certain desired distribution.

In particular N is at most 10. This ensures a compact design while still achieving a good homogenization. In certain cases N is a very small number, in particular 0, 1, 2 or 3. If compactness is important, these values of N create a particularly useful compromise. Obviously, situations may arise in practice whereby the length and thickness of the bar are not precisely matched to the number N, and it is certainly possible to achieve reasonable to good homogenization if the actual N in the bar deviates from the mathematically ideal natural numbers. However, it is preferable if the actual N in the bar deviates by no more than 20%, preferably no more than 10%, from the mathematically ideal value of (exactly) a natural number.

The thickness (cross section) of the bar is preferably between 1 and 15 mm. These values allow relatively efficient transfer of light within the bar, and in particular easy interception of the light in the entry surface. More preferably, the thickness is between 2 and 10 mm, for example 5 or 6 mm. These values represent a useful optimum of light interception options and compactness. After all, a thicker bar would also take longer to achieve the same homogenization.

The length of the bar is preferably short, in particular at most 1 m. It is advantageous for the length to be at most 25 cm, in order to allow an even more compact design. Still more advantageously, the length is between 25 and 100 mm. At these lengths, in combination with the abovementioned ratio between L, D and N, an optimum compact design with good light transfer and light homogenization properties is obtained. Other values are not fundamentally ruled out. However, by way of example, a length shorter than 25 mm will often entail a cross section which is so small that the light interception and transport power of the bar becomes impractically low. Obviously, the thickness and length of the bar are preferably related via the abovementioned ratio with the number n in it.

It is preferable for the bar to have a round cross-sectional profile. Obviously, other profiles are also possible, for example rectangular, square or polygonal. Other lengths are also possible, in particular significantly greater lengths if maximum homogenization is desired and dimensions are not restricted. For example, a length of 100*diameter/(n_bar*tan(mean size of the angle in the bar with respect to the optical axis)) is a good rule of thumb for excellent homogenization, although this quickly amounts to several metres, making it too large for many standard systems. In this context, n_bar is the refractive index of the material of the bar.

An advantageous illumination system according to the invention also comprises at least one additional homogenization bar with an entry surface, which can be displaced into a position in which the entry surface of the additional homogenization bar adjoins the exit surface of the homogenization bar. With an adjustable additional homogenization bar of this type, the homogenization properties can be easily and efficiently adapted, for example if a light source emitting a different light is switched on or if a light beam with even better homogenization is desired. One embodiment may, for example, be a hollow pipe which is mirror-coated on the inner side and fits over the bar. By extending the pipe to a greater or lesser extent, it is possible to adapt the homogenization length and therefore the illumination profile.

The homogenization bar is preferably displaceable with respect to the focal point of the elliptical mirror. This offers another way of adapting the intensity profile and the homogenization of the light beam, on account of the fact that the angle distribution of the light which is incident via the entry surface is then altered.

It is preferable for the entry surface to be positioned in or close to a second focal point of the elliptical mirror. This means that the dimensions of the entry surface of the homogenization bar can be kept as small as possible without loss of light. The term “near” is to be understood as meaning “at least within a distance of the entry surface which is such that the light spot which is produced is at least 90% within the entry surface”. Often, the imaging quality is not ideal, which means that the light spot has an inherent variation.

The LED used in the invention is not subject to any particular restrictions. However, it is preferable for the LED to comprise a high-power LED, for example with an electrical power of 3 W and a light yield of approx. 0.5 W. The spatial angle at which these LEDs radiate is typically of the order of 0.65*2π (i.e. approximately 70 degrees as a maximum angle) to 2π (90 degrees maximum angle). LEDs of this type create an intensity within a small wavelength range which can compete with filtered, much larger, mercury vapour lamps and the like. However, LEDs have additional advantages, such as a very long service life, switchability and much lower total power, i.e. lower generation of heat.

The light source advantageously comprises at least one additional light source, preferably an additional LED which emits in an additional direction which differs from an emission direction of the at least one LED. Providing a second light source makes the illumination system more flexible. It may comprise, for example, a spare light source, a light source of a different colour or a light source which emits in a different direction from the at least one (main) LED. In this latter embodiment, it is possible to intercept additional radiation in order thereby to make the original light beam wider. After all, many LEDs will emit in at most a hemisphere, so that combining two LEDs back-to-back provides a full sphere. It is easy to focus a relatively large part of this full sphere using a concave mirror, for example with an A of 1.2.

It should also be noted at this point that the A of the mirror is not necessarily equal to the angle supply of light which can be used in the illumination system. After all, an LED will be able to emit substantially at most a hemisphere, so that a mirror with an A greater than 1 in this case substantially only has to have a certain amount of clearance at the edge. In the case of a plurality of LEDs or the like, an A of greater than 1 can be used to actually reflect the additional light supplied to the homogenization bar. In this case, therefore, more light is intercepted. However, it should be noted that the angle supply of light is also increased, which is not always desirable. In particular, it may be advantageous to have a limited angle supply in the homogenization bar. This makes the homogenization easier but also provides a more compact light spot on the other side, i.e. at the exit surface of the bar. It should be noted that the interception of more light by supplying light at more angles (more than one LED or the like) is not itself responsible for a higher intensity in the light spot which emerges. For this reason in a particular embodiment it is preferred if the light source only emits in a direction away from the homogenization bar. Obviously, the mirror then focuses the light back towards the bar. However, it is relatively easy, in a compact system, nevertheless to keep the angle supply in the bar limited by using the properties of the mirror.

Preferably, the illumination system according to the invention also comprises an additional elliptical mirror with an additional focal point, the at least one additional light source, preferably the additional LED, being positioned in the additional focal point of the additional elliptical mirror. It is in this way possible to take into account the size of the additional light source, for example for cooling or control, and the additional light source can be provided with its own mirror, advantageously once again an elliptical mirror. The additional mirror may have different dimensions from the first (elliptical) mirror, for example a different focal distance, so that the additional light source can also be placed in a focal point, in such a manner that the focussed radiation from the additional light source also impinges on the entry surface.

Advantageously, the LED and/or the additional LED comprises an enclosure which substantially does not have any light-focussing properties. This is to be understood as meaning that the LED(s) preferably do not have any dedicated lens enclosure or the like. A transparent enclosure of this type, in the form of a lens, is often arranged so as to already focus the radiation of the LED to some extent. However, one drawback is that the optical qualities of a lens of this type still leave something to be desired. Moreover, flexibility of optical properties is lost, and cooling of the LED, for example, presents more problems. However, the possibility is of course not ruled out with certain modifications, of using an LED of this type in the illumination system according to the invention.

In a preferred embodiment, the light source and/or the additional light source comprises a laterally emitting LED. LEDs of this type are commercially available as, for example LEDs which, with the aid of an optical element (for example a mirror) attached to them, emit in a direction that is perpendicular to the optical axis of the LED. A light source of this type can, for example, provide annular illumination if desired. An LED of this type is also expedient as an additional light source, since the latter can then emit in a region which correctly adjoins the region where the at least one LED has a generally lower intensity, namely in the region around 90° to the optical axis of the at least one LED. Therefore, if a mirror with an associated high A of, for example, 1.2 is used, it is possible to achieve an effective increase in the intensity of the focussed radiation.

It is also possible to use LEDs and the like which have a different, desired emission profile, such as only in certain directions. It is in this way also possible, for example, to realize an annular or quadrupole illumination mode.

Advantageously, the LED and/or the additional LED comprises a cooling system, preferably a liquid cooling system. The entire cooling device may then be transparent, for example comprising water which flows through a Plexiglas plate with passages for the flow of water. The light yield of an LED decreases at higher temperatures. At a desired high light yield therefore, cooling the LED will create a higher light intensity. The known device achieves this using a Peltier element. However, this is a relatively complex and relatively inefficient cooling mechanism. The invention achieves better cooling with the aid of liquid cooling of the LED. This liquid cooling can be of very compact design, which may be advantageous with a view to minimizing loss of light, and moreover this liquid cooling can control the LED temperature very accurately.

It is preferable for the light source to comprise at least two LEDs, which preferably differ in terms of power and/or wavelength range and can advantageously be displaced separately to a position in the focal point of the elliptical mirror. In this embodiment, the light source can be switched between two or more LEDs. It is in this way possible to create different illumination conditions, such as a higher luminous intensity (for example for weaker fluorescence or a signal which is weaker in some other way) or a different wavelength (for example for a differently fluorescent substance). In an advantageous embodiment, the various LEDs are not present simultaneously in the concave mirror. The device which is known from DE 103 14 125 achieves the positioning of the LEDs with respect to the optical axis of the system by using a rotatable setting. If a compact concave mirror, in particular a concave mirror with an A of at least approximately 1, is used, this is unfavourable, since a large part of the mirror surface often has to be cut out in order to allow the rotation.

The separate LEDs can preferably be moved in translation. The use of a translational movement to move the LEDs, if appropriate in combination with one or more filters, has the advantage that this does not lead to any change in position of the light spot imaged onto the substrate, unlike in the event of an error in the rotation angle of the filter. Translational movement also offers advantages over a rotational movement with regard to the position with respect to the dichroic filter. After all, a minor positioning error will not cause any change in angle and therefore any change in transmission properties of the dichroic filter.

It should be noted here that the advantages which can be achieved with the homogenization bar(s) according to the invention are not restricted to LED light sources, but rather apply to any light beam that is to be homogenized, however it is generated. In this context, consideration can even be given to (incoherent) laser light which has already been provided with a desired additional angle supply using optical techniques (for example firstly widening a laser beam and then focussing it, and introducing it into the bar immediately after the focal plane), which often also has to be homogenized further.

In an advantageous embodiment of the illumination system according to the invention, this system also comprises a filter with a locally controllable transmission for the light from the light source, preferably comprising a liquid crystal arrangement or electrochromic filter arrangement. With the aid of a filter of this type, a defined spot on an object to be illuminated, such as a microscope substrate, can locally receive less light. This can be used to “switch off” objects which fluoresce very intensively. These objects, in addition to the fact that they swamp the detector, also have the property of emitting large amounts of light to locations which fluoresce only weakly or not at all. From these locations, the said light can then be scattered back to the detector, so that the inherently often weak light is swamped by scattered light originally emanating from these objects which fluoresce strongly. In other words, the signal-to-noise ratio can be improved in this way, by virtue of the fact that the illumination can be restricted to the desired regions.

A filter of this type can be designed in various ways, such as a liquid crystal arrangement or an electrochromic filter arrangement, but may also, for example, comprise a series of switchable mirrors or the like. Obviously, a suitable control has to be provided.

The position of a filter of this type is, for example, near to or in the exit surface of the homogenization bar or a conjugated plane. Thus, a more or less sharp image of the filter will always be passed on to the object to be illuminated, and control of the local illumination is optimal.

In another advantageous embodiment of the illumination system according to the invention, the latter also comprises a filter with a locally controllable transmission of the light from the light source, preferably comprising a liquid crystal arrangement or electrochromic filter arrangement. With the aid of a filter of this type, it is possible to adapt the pupil shape of the illumination and therefore the illumination shape in the following conjugated planes. In this context, consideration can be given, for example, to annular illumination or quadrupole illumination.

The invention also relates to a fluorescent illumination system, comprising an illumination system according to the invention, as well as an optical element with a transmission for light from the light source in a wavelength range about a first wavelength which differs from the transmission for fluorescent light in a wavelength range around a longer fluorescence wavelength. With a fluorescent illumination system of this type, it is possible, for example, for an object which exhibits fluorescence to be studied when it is irradiated with a specific type of light. This involves using an illumination system according to the invention which emits the type of light in question, as well as an optical element which can distinguish the fluorescent light from the first type of light mentioned, for example a bandpass filter or a high-pass filter. One example of a filter of this type is a dichroic filter, which transmits a specific wavelength band and reflects the remainder of the light or vice versa. It is in this way possible to separate the desired but weak fluorescence signal from the much stronger primary illumination. A principle of this type is known in the literature and requires no further explanation at this point. The advantage of the fluorescent illumination system according to the invention is that the light intensity which can be achieved is higher than for known LED systems, so that even weaker fluorescence signals can be reliably detected.

The invention also relates to a fluorescence microscope comprising an illumination system or fluorescent illumination system according to the invention. Furthermore, a fluorescence microscope of this type comprises the standard components, such as eyepiece, objective, substrate table and the like. However, these components will not be dealt with in more detail, since they are assumed to be known. Preferably, the illumination system can be switched between a fluorescence state, in which only a fluorescence signal can be perceived through the eyepiece, and a normal state, in which a normally illuminated substrate is visible through the eyepiece.

The invention will be explained in more detail on the basis of preferred embodiments and with reference to the appended drawing, in which:

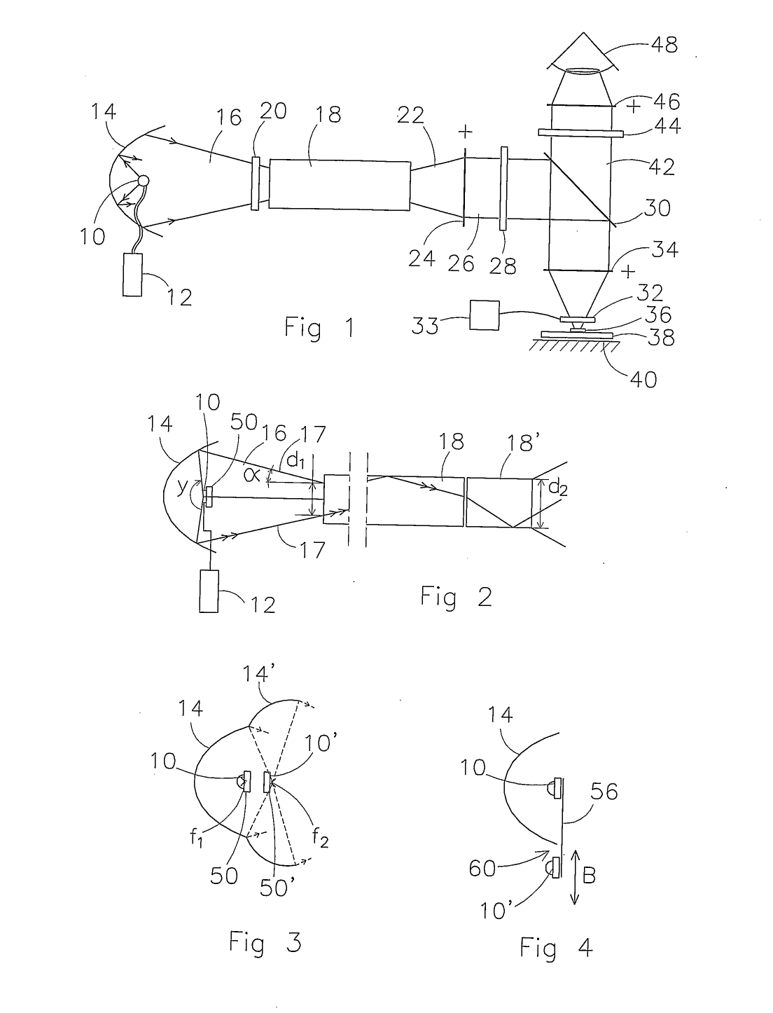

FIG. 1 shows a diagrammatic view of a fluorescence microscopy arrangement according to the invention;

FIG. 2 shows a diagrammatic view of an illumination system according to the invention;

FIG. 3 shows a diagrammatic view of another illumination system according to the invention; and

FIG. 4 diagrammatically depicts an illumination system according to the invention.

In FIG. 1, 10 denotes an LED which is connected to an LED controller 12. A convergent light beam 16 is emitted onto a homogenization bar 18 via an elliptical mirror 14. A divergent light beam 22 emerges from the homogenization bar 18 via diffuser 20 and this divergent light beam 22, via a first lens 24, becomes a substantially parallel light beam 26. The latter passes via excitation filter 28 and via dichroic mirror 30 and a filter with locally controllable transmission 32 with filter control 33, and via a second lens 34 as a focussed beam towards a substrate 36 on a substrate holder 38.

40 denotes an optional mirror which contributes to the fluorescent beam 42, which passes via an emission filter 44 and eyepiece 46 to the eye 48 of an observer.

In the above, the diffuser 20, the excitation filter 28, the filter 32 with filter control 33 and the mirror 40 are in each case optionally separate or in combination.

It should be noted that for the sake of clarity standard microscope components, such as tube, specimen table and the like, are not included in the drawing.

The LED 10 or if desired another substantially punctiform light source, emits light in a large spatial angle in a direction substantially away from the main light path. The light in this large spatial angle is collected and reflected by means of the concave mirror 14. The mirror is in this case elliptical, with the LED positioned substantially in a focal point of the ellipse. Alternatively, the mirror 14 may also be a different shape of mirror, but preferably such that a large proportion of the light emitted by the light source impinges on a homogenization bar 18.

The homogenization bar is in this case designed as a single, solid transparent body, for example made from glass, quartz, plastic, etc., but may also, for example, be concave, and internally mirrored or filled with gas or liquid. The cross-sectional shape of the homogenization bar 18 may, for example, be rectangular, square, round, etc. The homogenization bar 18 is used to homogenize the intensity distribution in the light beam by means of a plurality of internal reflections. In principle, a longer homogenization bar 18 provides better homogenization. On the other hand, in most appliances and systems there are restrictions in terms of the space which can be taken up. Therefore, in most cases it will be necessary to indicate an optimum length of the bar 18 which is a function of the diameter, the cross-sectional shape, and, for example, the refractive index of the material used in the bar 18.

Another, additional way of homogenizing is formed by diffuser 20, which in principle can be positioned at any desired spot in the light path between light source 10 and substrate 36. In this case, the diffuser 20 is positioned directly in the vicinity of the bar 18, since the light beam has a very small cross section there, and consequently the dimensions of the diffuser 20 can be kept restricted. One drawback of the diffuser is that the angle supply of the beam will increase, and consequently there is a risk of light being lost from the light beam. Nevertheless, adding the diffuser is a simple way of allowing further homogenization of the beam within a limited length of the system as a whole.

The diffuser 20 may comprise a small plate of a material which transmits the radiation used and which is provided, for example, with a surface structure, for example a collection of arbitrary scratches, etc. Other known diffusers such as a container holding a transmissive liquid with light-refracting particles etc. suspended in it are not ruled out.

The optics comprising first lens 24, excitation filter 28, dichroic mirror 30 and second lens 34 are in principle well known and therefore will only be discussed briefly at this point. The dichroic mirror 30 is used to reflect the light from the light source 10 towards the substrate 36, but to transmit fluorescent radiation which rebounds from the substrate 36 and has a different wavelength from the light emitted by the light source 10 substantially unimpeded. In general dichroic filters of this type comprise a number of alternating films of vapour-deposited dielectrics. A dichroic filter of this type has a filter/transmission characteristic which is highly angle-dependent. Therefore, the filter 30 has to be illuminated using a substantially parallel beam. Lens 24 is therefore also used to convert the divergent beam 22 into a substantially parallel beam 26. Second lens 34 then focuses the substantially parallel beam 26 back in such a manner that the substrate 36 can be efficiently illuminated. In fact, lens 34 can be considered as a type of objective. It should be noted that all the lenses in the arrangement shown, i.e. lens 24, lens 34 and lens 46 may also be combined lenses.

Of course, the dichroic mirror 30 has to be adapted to the light emitted by the light source 10 and to the expected fluorescent radiation of the substrate 36, in such a manner that the desired fluorescent radiation is sufficiently distinguishable from the original radiation of the light source 10.

The optional barrier filter 44 which is also known as an emission filter, can additionally be used to filter undesired radiation out of the rebounding fluorescent beam 42. Undesired radiation of this type may comprise residual radiation of the light emitted by the light source 10, which has not been blocked by the dichroic mirror 30, differing from the desired fluorescence, etc. In other words, a barrier filter 44 of this type can separate the fluorescent beam 42 from the original light beam 16.

Often, the barrier filter and/or the excitation filter also comprise a dielectric filter. Filters of this type have a transmission characteristic which is angle-dependent, which means that the transmission band is a function of the angle of incidence of the radiation impinging thereon. Therefore, an illumination system according to the invention may comprise a movable excitation filter and/or a movable barrier filter, in such a manner that the angle of the excitation filter and/or the barrier filter can be changed with respect to the incident radiation. It is in this way possible to transmit different parts of the spectrum and these parts can be used to sample a substrate without a change of filter and/or light source being required. It is in this context advantageous that, for example, an LED has a certain usable spectral width of, for example, a few tens of nanometres FWHM.

Via an eyepiece 46, the fluorescent beam 42 can be viewed by the eye 48 of the observer, or obviously also by a light-measuring device, a camera, etc.

FIG. 2 diagrammatically depicts an illumination system which may form part of the fluorescence microscopy arrangement shown in FIG. 1. In this figure, similar components are denoted by the same reference designations.

LED 10 in this case emits in a hemisphere, denoted by spatial angle γ. The elliptical mirror receives substantially all this radiation and reflects and focuses it in the forwards direction. On account of the hemisphere of the LED 10, the elliptical mirror has a relative interception angle A of 1.0. In fact, the elliptical mirror, if the LED 10 were to emit in even more directions, for example to the rear, can have an even higher numerical aperture, such as 1.2, etc. This is obviously considerably higher than could be achieved with a condenser lens.

The converging beam 16 is delimited by edge rays 17 which form a maximum angle α with the optical axis. This angle α is adapted to the desired numerical aperture to be achieved of, for example, 0.15-0.2. The edge rays 17 form the largest angle with the optical axis and will therefore be reflected most frequently in the homogenization bar 18. An edge ray of this type is denoted by the double arrow in the figure. By contrast, a ray which is parallel to the optical axis will in principle not be reflected at all. This gives rise to mixing of the various light rays, and the intensity distribution in the beam will be homogenized. One could say that the light beam 16 which impinges on the homogenization bar 18 and has a diameter D₁ with a numerical aperture A after homogenization has substantially the same A but a diameter of D₂ and obviously an improved, i.e. more homogenous intensity distribution.

As has already been described above, the length, diameter d and for example if desired also the refractive index of the homogenization bar 18 are adapted to the main length of the light used and to the maximum angle α, etc. To be able to use, for example, a different type of light, or a different angle α without making many modifications to the arrangement etc., the invention provides for an additional homogenization bar 18′ to be positioned behind the homogenization bar 18. This additional homogenization bar 18′ comprises an additional length of a material which is either the same as that of the homogenization bar 18 or has a different refractive index. The additional homogenization bar could also be a hollow body, etc. The purpose of the additional homogenization bar 18′ is to be able still to achieve an ideal intensity distribution profile for example at a slightly different wavelength.

The LED 10 is electrically powered by means of LED controller 12. This will be explained in more detail below. 50 denotes an LED cooling system which is used to keep the temperature of the LED as low as possible, or at least at a level which is as favourable as possible. An LED cooling system 50 of this type may, for example, comprise a Peltier element or preferably a liquid cooling system, such as water cooling. Water cooling offers the advantage of a higher cooling capacity. The power of an LED that has to be cooled is often only a few watts.

One major advantage of the invention is that it is very energy-efficient. Just a few watts of total power are sufficient, and consequently the entire illumination system can easily be run on batteries, which is a major advantage for portable use, for example in the medical sector, for examination of tissues.

LED controller 12 is used to switch the LED on and off. This switching on and off has (virtually) no effect on the service life of the light source, which contrasts with, for example, gas discharge lamps. It is therefore possible for the LED to be switched on only when light is desired, so that it is possible to make optimum use of the estimated service life of around 50 000 hours. In fact, this essentially constitutes a light source which never has to be replaced.

Another advantage of switching the LED is associated with the fact that an LED offers its highest intensity at a low temperature, for example just after it has been switched on. In particular, in the case of very brief illumination, there may be an additional benefit in using LEDs as light source, by then actuating them with a power which is higher than the nominal power. In the event of a brief overload, for example lasting at most 1 second, preferably lasting between 1 μs and 50 ms, there is no damage to the LED and it is possible to use a higher intensity, specifically higher by a factor of 2-5. This actuation is favourable, in particular, if examining phenomena whereby afterglow occurs, for example slow fluorescence or phosphorescence.

The LED can also be controlled separately on the basis of the light intensity which is generated. For this purpose, the LED control 12 can, for example, be coupled to a lightmeter (not shown) which measures the beam intensity and feeds back a signal to the LED control. It is in this way possible to obtain a very stable LED illumination. This stability can be increased still further when used in combination with LED cooling, so that the temperature of the LED, which has a considerable influence on the intensity, can be stabilized.

FIG. 3 shows a diagrammatic view of another illumination system according to the invention.

In this figure, 10 once again denotes an LED positioned in a focal point f1 of the elliptical mirror 14. 10′ denotes an additional LED which is positioned in the focal point f2 of additional elliptical mirror 14′. Cooling systems are denoted by 50 and 50′, respectively.

It can be seen from this figure that the elliptical mirrors 14 and 14′ differ in terms of their dimensions, on account of the different positions of the associated LEDs 10 and 10′, even though they preferably adjoin one another. In the figure, LED 10′ is a laterally emitting LED, the beam from which is denoted by the dashed lines. It is in this way possible to effectively increase the intensity of the overall beam, in particular if the intensity of the LED 10 is low at a large emission angle.

FIG. 4 diagrammatically depicts an illumination system according to the invention.

In this figure, 10 and 10′ are LEDs which are arranged on a support 56 that can be displaced in the direction of the arrow B, via a hole 60 in the mirror 14.

In this embodiment, it is easily possible to change LED, for example in order to select a different wavelength or intensity, while the surface area of the hole 60 can remain small and therefore the intensity losses are low. For example, there are numerous LEDs available in the visible and near UV wavelength regions. Most LEDs have bandwidths of for example approximately 50 nm FWHM, and consequently a plurality of LEDs are required to approximately cover the entire visible region.

The invention provides an illumination system which offers a high intensity in the generated light beam, which can also be made very homogenous and is very stable. Moreover, it can be switched on and off, and its colour and power can also be switched. Another major advantage of the invention is that it is extremely energy-efficient.

1. Illumination system, comprising
a light source with at least one LED which is designed to emit light;
an optical element with a focal point; and
a homogenization bar, comprising a body with an entry surface and an exit surface, which body substantially transmits the light of the light source,
the light source being positioned in the focal point of the optical element, in such a manner that light emitted by the light source can be reflected focussed by the optical element towards an entry surface of the homogenization bar,
the optical element comprising a concave mirror.

2. Illumination system according to claim 1, in which the concave mirror comprises an elliptical mirror, preferably with a relative interception angle A of at least 0.8, where A is equal to the (emitting spatial angle of the LED)/2π.

3. Illumination system according to claim 2, in which the entry surface is positioned in or close to a second focal point of the elliptical mirror.

4. Illumination system according to claim 1, in which the light source comprises at least one additional light source, preferably an additional LED, which additional light source emits in an additional direction which differs from an emission direction of the at least one LED.

5. Illumination system according to claim 4, also comprising an additional elliptical mirror with an additional focal point, the at least one additional light source, preferably the additional LED, being positioned in the additional focal point of the additional elliptical mirror.

6. Illumination system according to claim 1, in which the LED and/or the additional LED comprises an enclosure which substantially does not have any light-focussing properties.

7. Illumination system according to claim 1, in which the LED and/or the additional LED comprises a laterally emitting LED.

8. Illumination system according to claim 1, in which the LED and/or the additional LED comprises a cooling system, preferably a liquid cooling system.

9. Illumination system according to claim 1, in which the homogenization bar has a round cross-sectional profile with a diameter D, and a length L, where:
L=(N+½)*D/tan(mean size of the angle in the homogenization bar with respect to the optical axis),
where N=0,1, . . .

10. Illumination system according to claim 1, also comprising at least one additional homogenization bar with an entry surface, which can be displaced into a position in which the entry surface of the additional homogenization bar adjoins the exit surface of the homogenization bar.

11. Illumination system according to claim 1, in which the homogenization bar is displaceable with respect to the focal point of the elliptical mirror.

12. Illumination system according to claim 1, also comprising a filter with a locally controllable transmission for the light from the light source, preferably comprising a liquid crystal arrangement or electrochromic filter arrangement.

13. Illumination system according to claim 1, in which the light source comprises at least two LEDs which preferably differ in power and/or wavelength range and can be displaced separately to a position in the focal point of the elliptical mirror.

14. Fluorescent illumination system, comprising an illumination system according to claim 1, as well as an optical element with a transmission for light from the light source in a wavelength range about a first wavelength which differs from the transmission for fluorescent light in a wavelength range around a longer fluorescence wavelength.

15. Fluorescent microscope comprising a (fluorescent) illumination system according to claim 1.
